(19) United States
(12) Patent Application Publication
(10) Pub. No.: US 2009/0326792 A1
(43) Pub. Date: Dec. 31, 2009

(54) Method and system for increasing the degree of autonomy of an unmanned aircraft by utilizing meteorological data received from GPS dropsondes released from an unmanned aircraft to determine course and altitude corrections and an automated data management and decision support navigational system to make these navigational calculations and to correct the unmanned aircraft's flight path

(76) Inventor: Alan Thomas McGrath, Glenview, IL (US)

Correspondence Address: Alan McGrath, Apt. 201B, 4400 West Lake Ave., Glenview, IL, 60026, US

(21) Appl. No.: 12/151,178

(22) Filed: May 5, 2008

Related U.S. Application Data
(60) Provisional application No. 60/927,986, filed on May 6, 2007.

(51) Int. Cl. G05D 1/00; G06G 7/70; G06F 19/00; G01W 1/08

(52) U.S. Cl. 701/120; 701/4

(57) ABSTRACT

A system and method for determining wind profile and current icing potential information, comprising the steps of flying a plane; carrying a plurality of dropsondes on the plane; releasing the dropsondes into an atmosphere, for movement with a wind; collecting meteorology data by the dropsondes; transmitting the data from the dropsondes to the plane; transmitting the data from the plane to a remote control center; interpreting the meteorological data; and guiding the plane to a flight path with favorable winds and other favorable weather conditions. The invention also discloses an automated data management and decision support navigational system to make these navigational calculations and to correct the unmanned aircraft's flight path thus increasing the degree of autonomy of the unmanned aircraft.

### CROSS-REFERENCE TO RELATED APPLICATIONS

This application claims the benefit of provisional patent application Ser. No. 60/927,986 filed May 6, 2007 by the present inventor.

### BACKGROUND OF THE INVENTION

1. Field of Invention

This invention relates to the detection of head winds, tail winds, vertical windshear, weather fronts, areas where icing is likely to occur, and other meteorology data through the use of mini-dropsondes released from a conventional aircraft or from a UAV and to an automated data management and decision support navigational system to automatically turn the heading of the UAV to avoid unfavorable winds and areas where icing is likely to occur.

2. Prior Art

Unmanned Aerial Systems (UAS's), such as Northrop Grumman's Global Hawk®, and Unmanned Aerial Vehicles (UAV's), such as General Atomic's Predator®, are long-endurance, medium-altitude unmanned aircraft system for surveillance and reconnaissance missions. Surveillance imagery from synthetic aperture radar, video cameras and a Forward Looking Infrared (FLIR) can be distributed in real-time both to the front line soldier and to the operational commander, or worldwide in real-time via satellite communication links. During operation in Iraq and Afghanistan, the Predator® is flown by USAF pilots located in Nellis AFB. The aircraft and mission payloads are controlled via satellite data link. Sensor feeds are received in the mission control center back in USA via satellite where they are processed and analyzed. The imagery and intelligence products are distributed on the global intelligence network (DCGS) and are accessible to USAF and other forces worldwide. The air vehicle is equipped with UHF and VHF radio relay links, a C-band line-of-sight data link which has a range of 150 nautical miles and UHF and Ku-band satellite data links.

Some UAVs are designed to fly at over 35,000 feet and can stay aloft for more than 30 hours. Since weather fronts and/or icing conditions can move in over the 30 hours the UAV is aloft, and since the UAV's often fly in remote areas that don't have current weather data for different altitudes, maximization of flight time is difficult because the wind speeds and weather conditions such as potential for icing at different altitudes are difficult to estimate. If a UAV is flown at an altitude which has unknown strong headwinds, the result can be a sortie that lasts a few hours shorter than planned since a headwind can lead to the depletion of the fuel supply earlier than expected.

The fleet of MQ-1 Predator® unmanned aerial systems achieved a milestone of 200,000 flight hours in July 2006. According to the manufacturer, General Atomics, more than three-quarters of that time spent in combat for a total of 10,961 combat missions. According to an officer of the Aircraft Systems Group, General Atomics Aeronautical Systems, Inc. “the Predator® aircraft have flown nearly 100,000 flight hours over the past two years and are currently flying more than 6,000 flight hours per month while maintaining the highest operational readiness rates in U.S. Air Force inventory.”

However, according to a 2001 pentagon report, limitations of the Predator® are: 1) it performed well only in daylight and in clear weather, 2) it broke down too often, 3) it could not stay over targets as long as expected, 4) it often lost communication links in the rain, and 5) it was hard to operate.

In addition, experts say the Predator® has been particularly vulnerable to icing. A thin layer of ice on the wings, they say, can cause an aircraft to crash. The manufacturer has tried to fix the problem by installing a device that releases de-icing fluid along the drone's wings. But Air Force officials concede that the Predator® will still have trouble operating in severe icing conditions, which may limit its use over Afghanistan this winter. “This is not an all-weather aircraft,” a senior Air Force official said.

Ice in flight is bad news. It destroys the smooth flow of air, increasing drag while decreasing the ability of the airfoil to create lift. The actual weight of ice on an airplane is insignificant when compared to the airflow disruption it causes. As power is added to compensate for the additional drag and the nose is lifted to maintain altitude, the angle of attack is increased, allowing the underside of the wings and fuselage to accumulate additional ice. Ice accumulates on every exposed frontal surface of the airplane—not just on the wings, propeller, and windshield, but also on the antennas, vents, intakes, and cowlings. It builds in flight where no heat or boots can reach it. It can cause antennas to vibrate so severely that they break. In moderate to severe conditions, a light aircraft can become so iced up that continued flight is impossible. The airplane may stall at much higher speeds and lower angles of attack than normal. It can roll or pitch uncontrollably, and recovery might be impossible. Research has found that as little as 0.003 inch (0.08 mm) of ice on a wing surface can increase drag and reduce airplane lift by as much as 25 percent.

Ice can form on aircraft surfaces at 0 degrees Celsius (32 degrees Fahrenheit) or colder when liquid water is present. Although it is fairly easy to predict in the USA where the large areas of icing potential exist, the accurate prediction of specific icing areas and altitudes poses more of a quandary. Mountains, bodies of water, wind, temperature, moisture, and atmospheric pressure all play everchanging roles in weather-making.

In addition, all clouds are not alike. There are dry clouds and wet clouds. Dry clouds have relatively little moisture and, as a result, the potential for aircraft icing is low. The origin of a cold air mass is a key to how much supercooled water the clouds will carry.

Fronts and low-pressure areas are the biggest ice producers, but isolated air mass instability with plenty of moisture can generate enough ice in clouds to make light aircraft flight inadvisable.

Freezing rain and drizzle can also drastically roughen large surface areas or distort airfoil shapes and make flight extremely dangerous or impossible in a matter of a few minutes. Freezing rain occurs when precipitation from warmer air aloft falls through a temperature inversion into below-freezing air underneath. The larger droplets may impact and freeze behind the area protected by surface deicers.

In 2002 researchers from National Center for Atmospheric Research (NCAR), with funding from FAA, released an online system called CIP (Current Icing Potential). It provides high-precision maps of the USA, plots, and hourly updates to identify areas of potential aircraft icing produced by cloud droplets, freezing rain, and drizzle. CIP's Web-based display describes current icing conditions based on surface observations, numerical models, satellite and radar data, and pilot reports. Supercooled Large Droplet (SLD) icing conditions are characterized by the presence of relatively large, super cooled water droplets indicative of freezing drizzle and freezing rain aloft. These conditions, which are outside the icing certification envelopes (FAR Part 25 Appendix C), can be particularly hazardous to aircraft. A disadvantage of this system is that it is only available in the USA and some countries overseas.

A long-time problem associated with atmospheric research and forecasting is the lack of data points. Weather balloons are launched at various locations across the world twice a day, but even this provides sparse information. The idea of attaching instruments to commercial aircraft in order to expand the number of data points first originated in the Earth Systems Research Laboratory in Boulder, Colo.

Today many airlines in the USA are involved in this program and the amount of data now available has dramatically increased. Aircrafts Communication Addressing and Reporting System (ACARS), which is managed by Aeronautical Radio, Inc. (ARINC), is used by the involved airlines to transmit a variety of information such as longitude, latitude, time, temperature, wind direction and wind speed. About 140,000 observations from 4000 aircraft are recorded each day, with 100,000 of those over the United States.

Adverse weather is cited as one of the leading causes of aviation accidents, including more than one-third of all fatal accidents in all aviation sectors. Accurate, timely weather information in the cockpit can greatly increase flight safety, as well as efficiency. With up-to-date weather information at their fingertips, pilots can select routes to avoid deteriorating weather conditions and make better and more timely decisions about diversions to alternate landing facilities.

Investigators have attributed more than half of the 25 Predator® that have crashed to mechanical failure, weather, or operator error.

ARINC's Graphic/Text Weather Service (G/TWS) provides near-real-time text weather information to ACARS®-equipped aircraft using any of ARINC's GLOBAL^{SM} data link services—no matter where the aircraft is located. Received weather information is stored on a dedicated G/TWS server and is automatically overwritten as each update is received, eliminating the possibility of the aircrew using non-current data. A drawback of this system is that it is only available in some countries, like the USA.

Worldwide, there are over 800 upper-air observation stations and through international agreements data is currently exchanged between countries. The high altitude winds are obtained via balloon launched radiosondes from radiosonde stations. Over 75,000 radiosondes are released by the NWS each year. There are 92 radiosonde stations in North America and the Pacific islands and over 800 worldwide. These balloon launched sondes gather the data to draw the maps of the pressure and wind speeds at varying altitudes. These balloon launched sondes help plot the jet stream which circles the globe.

However, collecting this data over Afghanistan and Iraq is almost impossible due to the lack of commercial flights over there and due to the lack of weather balloon launch sites in these unhospital areas.

Dropwindsondes released by the Hurricane Hunter's Lockheed Martin WC-130 and Gulfstream aircraft have been used by the NCAR for years to gather meteorological data in areas where radiosondes can't be launched such as over the Gulf Coast during hurricane season. Disadvantages of this system are that the sondes are relatively big and bulky and are manually released over the Gulf Coast during hurricane season.

The Global Positioning System (GPS) is a satellite-based navigation system made up of a network of 24 satellites placed into orbit by the U.S. Department of Defense. GPS was originally intended for military applications, but in the 1980s, the government made the system available for civilian use. GPS works in any weather conditions, anywhere in the world, 24 hours a day. Since then the technology has evolved and is now capable of very accurate X, Y, and Z location determination while recording the time of each measurement. U.S. Pat. No. 7,362,265 issued on Apr. 22, 2008, and it covers some of this new technology. It's title is, “Process for accurate location determination in GPS positioning system.” In addition, the GPS receivers have been reduced in size over the years and some are located inside cell phones.

U.S. Pat. No. 6,421,010, which issued on Jul. 16, 2002, covers atmospheric sondes and a method for tracking:
A system for wind profiling comprises sondes for being borne through the atmosphere by balloons and transmitting signals enabling identifying the sondes, and received by receivers capable of determining the angle of arrival (AOA) of the signals from the sondes, so that they can be tracked. In the preferred embodiment, the signal transmitted by each sonde is a phase-shift-keyed (PSK) signal. The carrier phase difference as measured at two spaced antennas is measured to provide an accurate but ambiguous measure of the difference in distance of the path length between the sonde and receivers, and the symbol phase difference is employed to remove the ambiguity. The difference in path length is then used to determine AOA. Atmospheric data and the sonde identification are encoded using a psuedo-random sequence (PRS) of the PSK symbols.

A disadvantage of this patent is that its launch platform is a balloon and it uses three receivers at its base station to determine the location of the dropsonde.

U.S. Pat. No. 4,899,583, which issued on Feb. 13, 1990, covers atmospheric sounding apparatus:
An atmospheric sounding unit is provided which is capable of being launched from an aircraft. The unit includes atmospheric sounding instrument such as a rawinsonde for, in operation, providing desired atmospheric soundings; a balloon connected to the sounding instrument; a gas source, e.g., a gas tank, for a lighter-than-air gas; an arrangement for filling the balloon with the gas; and a sensor for sensing the approach of the unit to the Earth and for providing release of the balloon with the sounding instrument connected thereto from the remaining components of the unit when a predetermined approach condition, e.g., contact with water, is sensed. Upon release, the balloon is permitted to ascend and the sounding instrument produces soundings during the ascent of the balloon into the atmosphere. A system of parachutes controls the descent of the unit after the launching thereof from the aircraft.

A disadvantage of this patent was that in 1990 dropsondes were big and bulky and in addition they were incapable of using modern day GPS tracking technology.

U.S. Pat. No. 6,937,937, which issued on Aug. 30, 2005, covers airborne based monitoring:
A weather monitoring and prediction system that uses a fleet of aircraft to obtain data. Each aircraft has a local air data system that facilitates the measurement, recordation, and transmittal of local atmospheric data such as barometric pressure, and the corresponding temporal, positional, and altitudinal data. The data is electronically transmitted from each aircraft to a ground based processing system where it is stored. The data may then be transmitted to subscribing users such as aircraft, other weather data systems or to air traffic control centers in either a compiled form or in a raw form. Another embodiment also provides for measuring barometric pressure as a function of altitude at an in-flight aircraft.

A disadvantage of this patent is that no sondes are used. Wheather data is collected using monitoring instruments located on the airplane.

U.S. Pat. No. 5,420,592, which issued on May 30, 1995, covers GPS Sensors and a balloon means for carrying a rawinsonde:
A rawinsonde system embodiment of the present invention includes a digital GPS snapshot buffer and a serial communications controller for transmitting message frames formed of a combination of digital GPS data from the snapshot buffer and digitized hardwired meteorological data input from a humidity-temperature-pressure instrument. The message frames are telemetered at a relatively low rate over a meteorological radio band to a ground station. Substantially all of the conventional GPS digital signal processing is performed by the ground station, including carrier recovery, PRN code locking, pseudo-range extraction, ephemeris data extraction, almanac collection, satellite selection, navigation solution calculation and differential corrections. Ground processing further includes Kalman filter wind velocity calculation.

A disadvantage of this patent is that the GPS technology that was available in 1995 was no where as good as the GPS technology available in 2008. Also, the sonde covered by this patent was a rawinsonde that is carried to the upper atmosphere by a balloon.

U.S. Pat. No. 7,158,877, which issued on Jan. 2, 2007, covers waypoint navigation:
The invention relates to remote control of an unmanned aerial vehicle, UAV, from a control station by means of a wireless command link. The UAV may be controlled in an autonomous mode wherein it flies according to a primary route defined by a first set of predefined waypoints. The UAV may also be controlled in a manual mode wherein it flies according to an alternative primary route defined in real-time by control commands received via the wireless command link. Flight control parameters are monitored in both modes, and in case a major alarm condition occurs, the UAV is controlled to follow an emergency route defined by a second set of predefined waypoints.

A limitation of this patent is that it doesn't use wind or weather data to determine the UAVs route.

U.S. Pat. No. 7,365,674, which issued on Apr. 29, 2008, is titled, “Airborne weather profiler network,” and its abstract states:
Apparatus and methods for remotely sensing meteorological conditions and for building models from the sensed conditions. More particularly, networks and systems are provided for gathering remotely sensed profiles of the meteorological conditions and for building the meteorological model. The networks and systems can also predict the weather. Also, various remote profilers are provided including LIDAR, RADAR, nano-sondes, microwave, and even GPS (Global Positioning System) related instruments.

A disadvantage of this patent is that it doesn't cover making course corrections in real time as soon as the meteorological data is received by the UAV or remote pilot. Aerosonde is a small UAV that is designed to fly over oceans in order to collect weather data including temperature, atmospheric pressure, humidity and wind measurements. The Aerosonde is a small unmanned aerial vehicle (UAV) designed to fly over oceans in order to collect weather data, including temperature, atmospheric pressure, humidity, and wind measurements. The Aerosonde was originally manufactured by Insitu however it currently manufactured by Aerosonde Ltd. The Aerosonde is powered by a modified Enya R120 model aircraft engine, and carries onboard a small computer, meteorological instruments, and a GPS receiver for navigation. Payload is only 5 pounds.

A disadvantage of this method of collecting weather data by a UAV is that the Aerosonde mini plane uses no dropsondes since its payload is only 5 pounds. Weather data is collected using monitoring instruments located only on the small UAV.

Recently, the NCAR has been working on the Inter-Continental Atmospheric Radiosonde Upper-Air Sounding System (ICARUSS) project. It involved a balloon that carried and released 35 miniature radiosondes on its journey from Africa to South America. It was developed by U.S. and French researchers working for the NCAR, its parent organization the University Corporation for Atmospheric Research (UCAR), and the French Space Agency CNES. In a unique collaboration, U.S. and French researchers launched large, specialized balloons into the stratosphere to drop nearly 300 instrument packages over wide swaths of Africa and the Atlantic Ocean.

Twice per day, each gondola released dropsondes, an instrument package that falls by parachute, sensing the weather during its 20-minute descent and radioing data back to the gondola and then, by satellite, to the researchers. These unique dropsondes are much smaller than their predecessors.

Miniaturization of the sonde has recently become possible due to, in part, the miniaturization and improvements of battery technology.

In the next 25 years we are bound to go to war with somebody. When we do, it is likely that they will cease sharing their daily high level wind radiosonde data/synoptic chart data and their CIP data with us. For example, if the U.S.A. were to go to war with state A, and if state A currently has 200 of these weather balloon stations, and if state A were to stop disclosing this data, then the USAF would be launching missions into an area of unknown wind and weather conditions.

### BRIEF SUMMARY OF THE INVENTION

In order to overcome these and other problems in the prior art, the present invention discloses a system and method for determining wind profile and current icing potential information, comprising the steps of flying a plane; carrying a plurality of dropsondes on the plane; releasing the dropsondes into an atmosphere, for movement with a wind; collecting meteorology data by the dropsondes; transmitting the data from the dropsondes to the plane; transmitting the data from the plane to a remote control center; interpreting the meteorological data; and guiding the plane to a flight path with favorable winds and other favorable weather conditions. The invention also discloses an automated data management and decision support navigational system to make these navigational calculations and to correct the unmanned aircraft's flight path.

### OBJECTS AND ADVANTAGES

It is an object of the present invention to provide meteorological data such as wind direction, wind magnitude, and current icing potential over remote areas and over hostile territory where it is difficult to obtain such information.

It is an object of the present invention to increasing the degree of autonomy of an unmanned aircraft by utilizing meteorological data received from GPS dropsondes released from an unmanned aircraft to determine course and altitude corrections to permit an unmanned aircraft to increase its time over the target by following tailwinds, avoiding headwinds and wind shear, and avoiding areas where icing is likely to occur.

It is an object of the present invention to incorporate an automated data management and decision support navigational system in a UAV to make navigational calculations based on current weather data and to correct the unmanned aircraft's flight path.

### BRIEF DESCRIPTION OF THE DRAWINGS

These and other features, benefits, and advantages of the present invention will be made apparent from the following descriptions, figures, and appended claims, wherein like reference numerals refer to like structures across the several figures.

FIG. 1 shows the dropsonde system,

FIG. 2 shows the sonde launch platform,

FIG. 3 shows the 30 sondes ready for a sortie,

FIG. 4 shows the sonde with its parachute,

FIG. 5 shows a cutaway of the miniature dropsonde,

FIG. 6 shows a block diagram over a signal processing system according to an embodiment of the invention,

FIG. 7 shows a flow chart which summarizes the operation of the automated system, and

FIG. 8 shows a UAV and its on-board flight control system.

### LIST OF REFERENCE NUMERALS

1 Dropsonde
2 Dropsonde launch platform
3 Dropsonde Parachute
4 Temperature Sensor
5 Humidity Sensor
7 Dropsonde Radio Transmitter
8 GPS receiver
9 GPS Antenna
10 Dropsonde Microprocessor
14 Sonde launch tube
16 Electronics Bay
17 Satellite Transceiver
18 Lithium Batteries
19 Satellite
20 Earth
21 Signal from the Dropsonde
22 Signal between the UAV and the Satellite
23 Signal between the remote control center and the satellite
40 Air Vehicle
41 Air Vehicle antenna
43 flight control device
48 Remote pilots
49 Remote control center
60 signal processing system
61 on-board flight control system
62 autonomous control sub-system
63 manual control sub-system
64 a functional monitoring system
65 central processing unit
66 wireless interface unit
67 interfacing unit
71 represents a participating UAV.
72 represents the release of a Dropsonde
73 represents the gathering of meteorological data by the Dropsonde
74 represents the transmission of that data to the UAV
75 represents the calculation of the wind vector
76 represents the calculation of the CIP
77 represents the comparison of the data
78 represents a decision to determine if a course correction is needed
79 represents a course correction
80 represents a decision to determine if there are any more sondes to be launched

### DETAILED DESCRIPTION

### Preferred Embodiment

This description and the accompanying drawings illustrate specific embodiments in which the present invention can be practiced, in enough detail to allow those skilled in the art to understand and practice the invention. Other embodiments, including logical, electrical, and mechanical variations, are within the skill of the art. Other advantages and features of the invention not explicitly described will also appear to those in the art. The scope of the invention is to be defined only by the appended claims, and not by the specific embodiments described below.

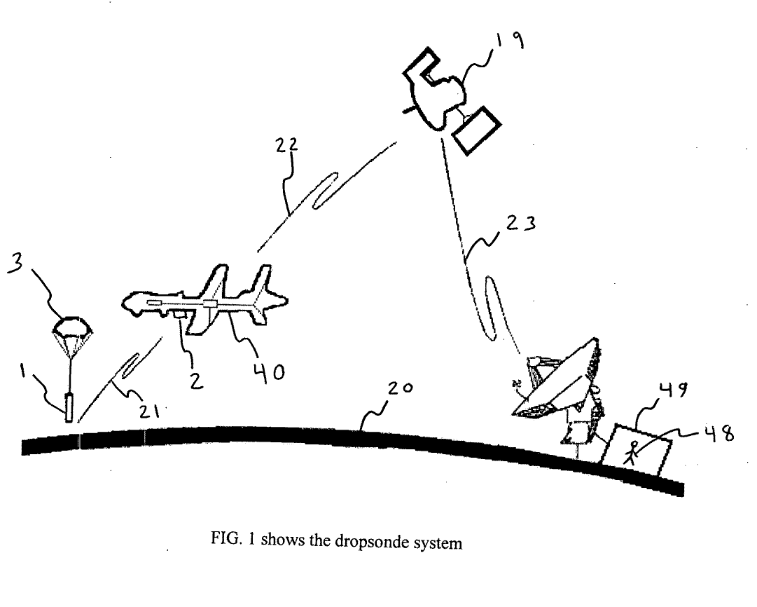

FIG. 1 shows the dropsonde system. One component of the invention is a plane or unmanned aerial vehicle (UAV) 40. There are several UAVs 40 in use today. They all have different carrying capability. Their payloads vary from 5 pounds to 3,000 pounds. During operation in Iraq and Afghanistan, UAVs 40 are flown by pilots 48 located in Nellis AFB in Nevada, or at a base in California, at a remote control center 49. This is accomplished through the use of signals between the UAV 40, a satellite 47, and the UAVs remote control center 49. The remote pilots 48 control the heading of the vehicle through the use of signals 23 between the remote control center and the satellite which is then relayed to the UAV 40 by signals 22 between the UAV 40 and the satellite 19.

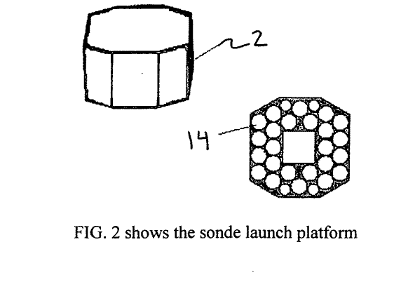

FIG. 2 shows the sonde launch platform 2 which is attached to the UAV 40. The platform 2 is comprised of a plurality of sonde launch tubes 14. The weight of the launch platform 2 includes the weight of the individual ICARUSS type miniature dropsondes 1 (also referred to as wind-dropsondes, sondes, and radio-dropsondes.)

The sonde release mechanism would either be programmed to automatically release the sondes 1 or they could be released by the remote pilot 48 manually. The launch platform 2 could also be carried by a manned plane.

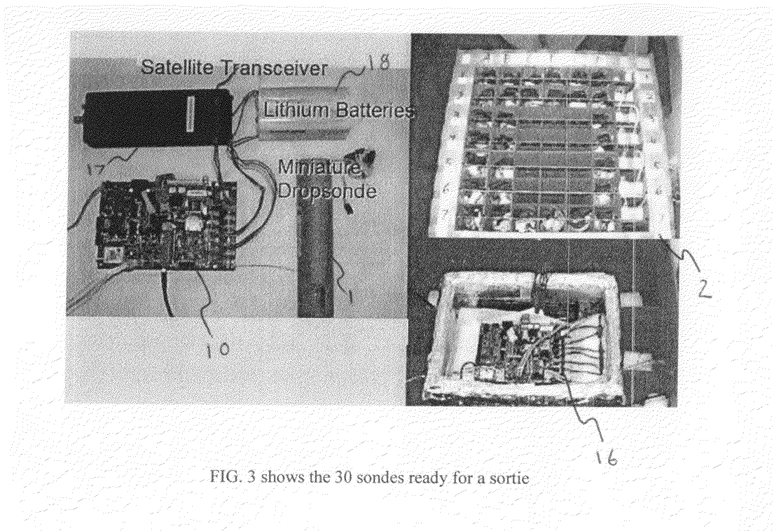

FIG. 3 shows thirty sondes 1 packed into their launch platform 2 and ready to be attached to the UAV 40 for a sortie.

The miniature dropsondes 1 are meteorological measuring instruments for periodically testing the atmosphere and for outputting a signal 21 comprising information related to the tests. The signal 21 is relayed to the UAV 40. Each dropsonde contains sensors to determine its location, the temperature, humidity and pressure of the atmosphere. Each dropsonde 1 weighs about 5 ounces and is about the size of a small water bottle. Each ICARUSS type miniature sonde 1 costs approximately $250.00. Therefore, a sortie where thirty sondes are launched by the UAV 40 on the UAV's 40 trip to the target would cost $7,500 for the sondes. However, this expense is worth it if a series of sorties is planned for that day and if weather conditions are marginal.

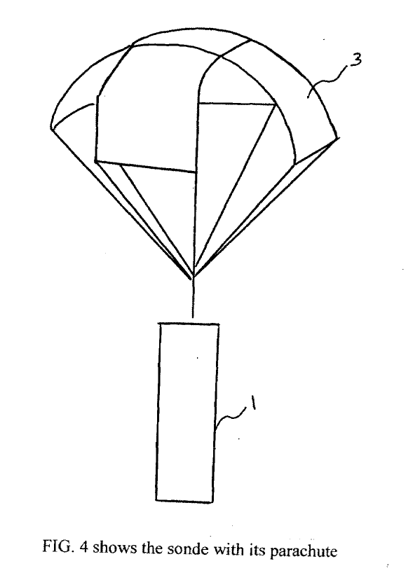

FIG. 4 shows the dropsonde 1 and its parachute 3. Each ICARUSS dropsonde 1 takes about 20-30 minutes to descend to the ocean or the ground 20, depending on its launch height, by parachute 30.

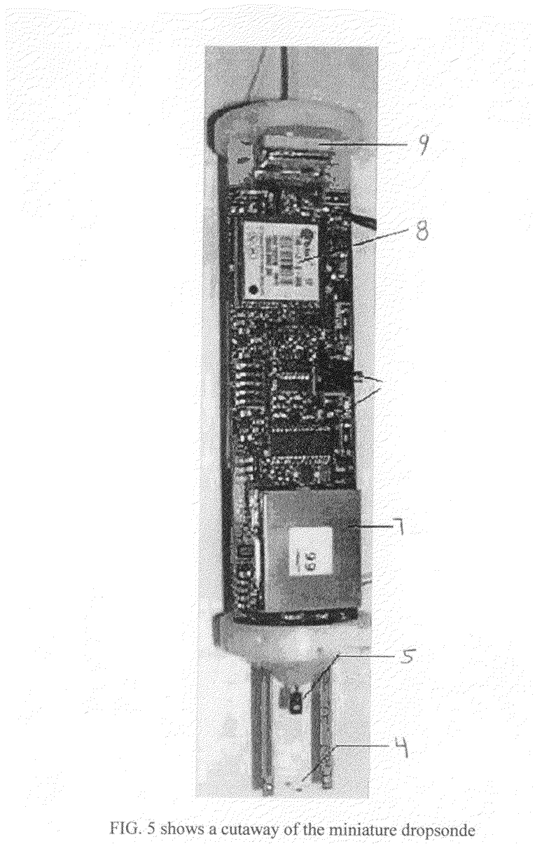

FIG. 5 shows a cutaway of the dropsonde 1. Visible are its temperature sensor 4, humidity sensor 5, and the GPS receiver 8. The data gathered from one miniature dropsonde 1 would be pressure (P), temperature (T), humidity (H), its three dimensional location (L) and the time (T) of each measurement. Wind speed (S) and direction (D) can be easily determined from measurements taken at known intervals since the miniature dropsonde 1 will drift with the wind. The stronger the wind is, the more it will drift during its decent. Altitude (A) will also be measured via the GPS receiver 8. It is well known in the art how the GPS receiver determines the x, y, z coordinates.

For example, GPS receivers used in cell phones are now capable are now capable of determining the users altitude if signals from at least 5 satellites are used for 3-dimensional positioning.

Current icing potential (CIP) can be determined from the humidity and temperature readings. S and D could be combined into a vector (V) providing the direction and magnitude of the wind.

The data gathered by the sondes 1 would be relayed back to the UAV 40 and then the data would be relayed back to the remote control center 49.

### Operation of the Preferred Embodiment

When the dropsondes 1 are released over an area, the weather data will be relayed back to the remote control center 49. A meteorologist there could then begin to draw synoptic charts, wind charts and areas where icing is likely to occur. These charts could then be used to brief the remote pilot 48 to help her decide which altitude the UAV 40 should be flown at and which course the UAV 40 should follow.

As an example, just one sonde could record the atmospheric conditions at 5,000 foot intervals from 50,000 feet down to 20,000 feet. If thirty sondes 1 are released during the UAV's 40 outbound journey, the database would be comprised of thousands of data values at different altitudes. These values would permit the meteorologist to quickly begin roughing out the winds at different altitudes by plotting the wind vectors and other meteorological data.

If the meteorologist were to collect other sets of data from other UAVs 40 traveling nearby, the meteorologist could then plot more accurate synoptic charts.

It is well known in the art that when a front passes over an area, it is marked by changes in temperature, moisture, wind speed and direction, atmospheric pressure, and often a change in the precipitation pattern. The data gathered by the UAV's 40 sondes 1 is the basic data needed to plot storm fronts. When the warm front approaches the wind direction changes, dew point temperature rises, humidity increases, there is extensive cloud cover and the atmospheric pressure drops. The cold front has similar surface characteristics—the wind changes direction and blows more strongly, forming a line squall, temperature decreases, humidity decreases, precipitation can occur and the atmospheric pressure decreases.

The passage of a cold front usually results in velocity changes in winds and creates vertical movement of air (turbulence) and can set off atmospheric disturbances such as rainshowers, thunderstorms, squall lines, tornadoes, and snowstorms ahead of and immediately behind the moving cold front. These are areas the UAV 40 should avoid.

Since the data gathered by the UAV's 40 sondes 1 will include temperature, pressure and humidity, this data can also be used to determine the current icing potential for various altitudes. The more data that is collected, the more accurate these charts will be.

### Additional Embodiments

A semi-autonomous system could bypass the meteorologist and provide information about favorable and unfavorable routes directly to the remote pilot 48. This onboard system would be capable of storing the information gathered by the dropsondes 1 in a database, searching the database for favorable and unfavorable winds, searching the database for current icing potential, and relaying that information directly to UAV remote pilot 48.

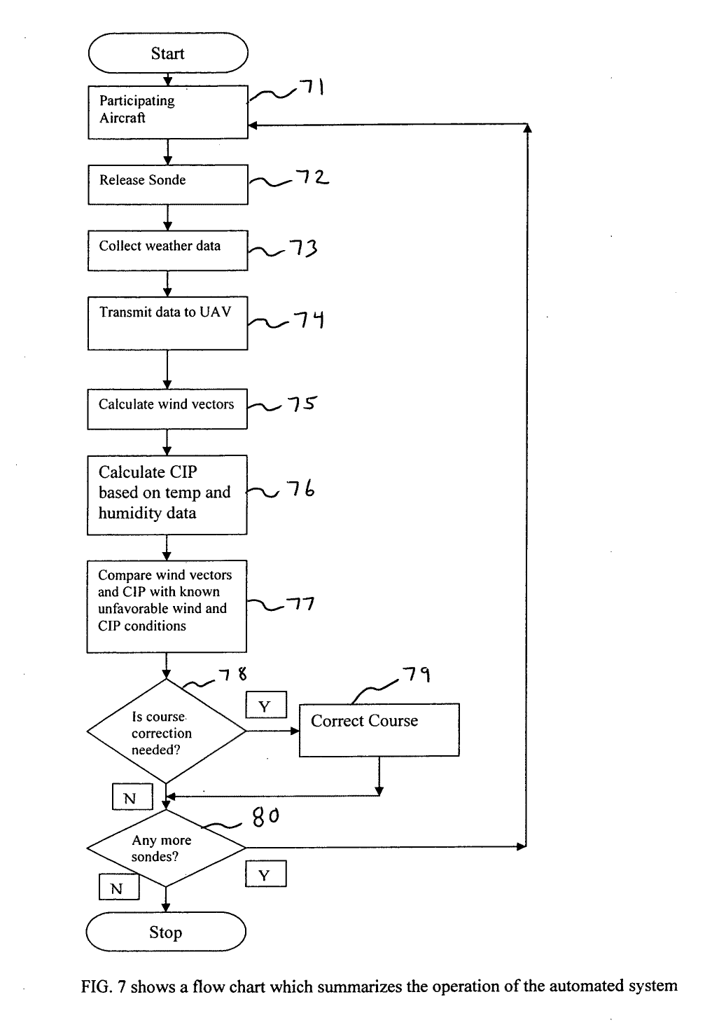

The flow chart shown in FIG. 7 provides an example of how a completely autonomous embodiment of the invention would work. Block 71 represents a participating UAV 40. Block 72 represents the release of a dropsonde 1. Block 73 represents the gathering of meteorological data by the dropsonde 1. Block 74 represents the transmission of that data to the UAV 40. Block 75 represents the calculation of the wind vector by the central processing unit 65. Block 76 represents the calculation of the CIP by the central processing unit 65. Block 77 represents the comparison of the data generated by blocks 75 and 76 to known unfavorable weather conditions. Block 78 represents a decision to determine if a course correction is needed. If required, block 79 represents a course correction. Block 80 represents a decision to determine if there are any more sondes 1 to be launched.

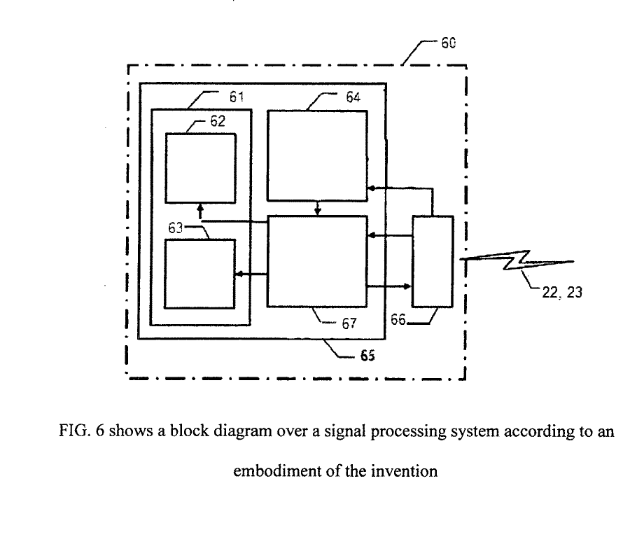

FIG. 6 shows a block diagram over a signal processing system 60 according to an embodiment of the invention which includes a central processing unit 65 and a wireless interface unit 66. An on-board flight control system 61, a functional monitoring system 64 and an interfacing unit 67 are included in the central processing unit 65.

The on-board flight control system 61, in turn, contains an autonomous control sub-system 62 and a manual control sub-system 63. The autonomous control sub-system 62 is adapted to control the vehicle to fly around areas of unfavorable winds, windshear, or areas with unfavorable CIP. Correspondingly, the manual control sub-system 63 is adapted to control the vehicle to fly according to a primary route, however in accordance with real-time commands received from the remote control station 49. These commands arrive via the satellite 19, signals 22 between the UAV 40 and the satellite 19, the wireless interface unit 66 and the interfacing unit 67 in the central processing unit 65. The wireless interface unit 66 is also adapted to send any status messages generated by the functional monitoring system 64 to the remote control station 49.

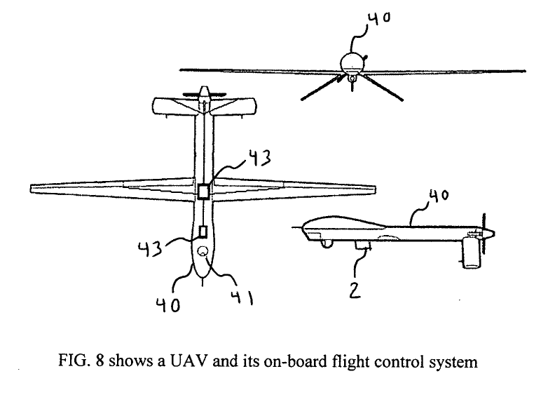

FIG. 8 shows a UAV 40, its on-board flight control device 43, and the sonde launch platform 2. The flight control system 61 is connected to the flight control device 43.

If information collected from dropsondes 1 launched from other UAV's 40 are added to the database, the result would be a more accurate representation of current weather conditions.

### CONCLUSION

The foregoing description of a preferred embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method for determining wind profile and current icing potential information, comprising the steps of:
a) flying a plane;
b) carrying a plurality of dropsondes on the plane;
c) releasing the dropsondes into an atmosphere, for movement with a wind;
d) collecting meteorology data by the dropsondes;
e) transmitting the data from the dropsondes to the plane;
f) transmitting the data from the plane to a remote control center;
g) interpreting the meteorological data; and
h) guiding the plane to a flight path with favorable winds and other favorable weather conditions.

2. The method according to claim 1, wherein the plane is an unmanned aerial vehicle.

3. The method according to claim 1, wherein the meteorology data is atmospheric temperature, humidity, pressure, wind direction, wind magnitude, and location where the data was recorded.

4. The method according to claim 1, wherein the data collected in step (d) is collected at a plurality of altitudes.

5. The method according to claim 1, wherein the plane of step (a) is a plurality of planes each carrying the dropsondes.

6. A flight control system for controlling the flight of an aircraft through windy and icing conditions, the system comprising:
a) a plurality of dropsonde means for measuring meteorological values of the atmosphere;
b) a receiver on the aircraft for collecting the data gathered by the dropsondes and transmitted by the dropsondes;
c) a control system for operating flight control devices on the aircraft; and
d) a wind and a current icing potential detection system located on the aircraft, the wind and current icing potential detection system using at least some of the measured values of the atmosphere to calculate a wind vectors and a current icing potential during flight for comparison to pre-determined values in a table for determining whether an unfavorable wind conditions or an unfavorable current icing potential exist;
e) wherein the control system operates at least some of the flight control devices in response to an output of the wind and current icing potential detection system.

7. The flight control system of claim 6, wherein the aircraft is a unmanned aerial vehicle.

8. The flight control system of claim 6, wherein the meteorology values are atmospheric temperature, humidity, pressure, wind direction, wind magnitude, and location where the data was recorded.

9. The flight control system of claim 6, wherein the data gathered by the dropsondes is collected at a plurality of altitudes.

10. The flight control system of claim 6, wherein the aircraft is a plurality of aircrafts each carrying the dropsondes.

11. A method of controlling the flight of an aircraft in windy and current icing potential conditions, the method comprising:
(a) releasing a plurality of dropsonde means for measuring meteorological values of the atmosphere;
(b) collecting meteorology data by the dropsondes;
(c) transmitting the data from the dropsondes to the plane;
(d) calculating wind vectors and current icing potential during flight for comparison to predetermined values in a table for determining whether an unfavorable wind condition or an unfavorable current icing potential exist;
(e) when wind or current icing potential values exceeds a selected value in the table indicating unfavorable winds or current icing potential conditions, automatically operating flight control devices on the aircraft so as to minimize the effects of the wind or current icing potential conditions on the flight of the aircraft.

12. The method according to claim 11, wherein step (e) comprises automatically turning the heading of the aircraft.

13. The method according to claim 11, wherein the aircraft is a unmanned aerial vehicle.

14. The method according to claim 11, wherein the meteorology data is atmospheric temperature, humidity, pressure, wind direction, wind magnitude, and location where the data was recorded.

15. The method according to claim 11, wherein the data gathered by the dropsondes in step (b) is collected at a plurality of altitudes.

16. The method according to claim 11, wherein the aircraft from which the dropsondes are released are a plurality of aircrafts each carrying the dropsondes.
